(19) United States
(12) Patent Application Publication
(10) Pub. No.: US 2025/0386175 A1
(43) Pub. Date: Dec. 18, 2025

(54) SYSTEMS AND METHODS FOR SELECTIVE ATTESTATION FOR EMERGENCY CALLS

(71) Applicant: T-Mobile Innovations LLC, Overland Park, KS (US)

(72) Inventors: Khurram MIRZA, Renton, WA (US); Srinivasa Rao BODAPOTULA, Bellevue, WA (US); Dinko DINKOV, Kirkland, WA (US); Hilah ROZIER, Lenexa, KS (US)

(21) Appl. No.: 18/740,633

(22) Filed: Jun. 12, 2024

(51) Int. Cl. H04W 4/90; H04W 4/16; H04W 12/06; H04W 80/10

(52) U.S. Cl. CPC H04W 4/90; H04W 4/16; H04W 12/06; H04W 80/10

(57) ABSTRACT

Systems and methods are provided for selective attestation for emergency calls. An example method may include receiving a call request for a wireless device from a proxy server. The method may further include determining whether the destination network for the call request supports emergency call signing. The method may further include, in response to determining that the destination network for the call request does not support emergency call signing, removing identity attestation headers from the call request.

### TECHNICAL BACKGROUND

A wireless network, such as a cellular network, can include an access node (e.g., base station) serving multiple wireless devices in a geographical area covered by a radio frequency transmission provided by the access node. Access nodes may deploy different carriers within the cellular network utilizing different types of radio access technologies (RATs). RATs can include, for example, 4G RATs (new radio (NR)). Further, different types of access nodes may be implemented for deployment for the various RATs. Evolved NodeB (eNodeB or eNB) may be utilized for 4G RATs. Next generation NodeB (gNodeB or gNB) may be utilized for 5G RATs.

Placing a cellular phone call uses many different resources within the cellular providers network, including many different server functions. These server functions work together to coordinate the call process. Emergency calls, such as those to 911, may be prioritized within the cellular network. However, measures are generally taken to ensure that only true emergency calls are prioritized such that the cellular network functions efficiently.

### OVERVIEW

Examples described herein include systems and methods for selective attestation for emergency calls. An exemplary method includes receiving a call request for a wireless device at a proxy server. The method further includes determining whether a destination network for the call request supports emergency call signing. The method further includes in response to determining that the destination network for the call request does not support emergency call signing, removing headers from the call request, the headers providing identity attestation for the wireless device.

Another exemplary method includes receiving at a Proxy Call Session Control Function (P-CSCF) server an emergency call request from a wireless device. The method further includes forwarding the emergency call request to an Emergency Call Session Control Function (E-CSCF) server. The method further includes determining whether a Public Safety Answering Point (PSAP) of a destination network for the emergency call request supports emergency call signing. The method further includes in response to determining that the PSAP of the destination network for the emergency call request does not support emergency call signing, removing identity attestation headers from the emergency call request.

Another exemplary embodiment includes a system with a proxy server and an emergency call management server. The emergency call management server includes at least one electronic processor configured for executing instructions to perform operations. The operations include receiving a call request for a wireless device from the proxy server. The operations further include querying a Gateway Mobile Location Center to determine whether a destination network for the call request supports emergency call signing. The operations further include in response to determining that the destination network for the call request supports emergency call signing, forwarding the call request with headers providing identity attestation for the wireless device.

### BRIEF DESCRIPTION OF DRAWINGS

These and other more detailed and specific features of various embodiments are more fully disclosed in the following description, reference being had to the accompanying drawings, in which:

FIG. 1 illustrates an example system for wireless communication in accordance with various aspects of the present disclosure;

FIG. 2 illustrates an exemplary operating environment for selective attestation for emergency calls in accordance with various aspects of the present disclosure;

FIG. 3 illustrates an example processing node in accordance with various aspects of the present disclosure;

FIG. 4 illustrates an example process flow for selective attestation for emergency calls; and

FIG. 5 illustrates an example process flow for selective attestation for emergency calls.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In accordance with various aspects of the present disclosure, a wireless network may be provided by many components working together. Some of these components include access nodes, Gateway Mobile Location Centers (GMLC), Secure Telephony Identity-Authentication Services (STI-AS), Session Border Controllers (SBCs), Public Safety Answering Points (PSAP), and the IP Multimedia Subsystem (IMS). The IMS includes many server functions, such as the Proxy Call Session Control Function (P-CSCF), and the Emergency CSCF (E-CSCF). There are many more components used in providing a wireless network that are omitted here for clarity.

Emergency calls, such as calls to 911, may get prioritized on a cellular provider's network. This may be important at times of heavy congestion to ensure that these important calls successfully connect and stay connected. Some previous methods of prioritizing emergency calls include adding headers indicating that the call request should be prioritized. For example, the “Resource-Priority” header, defined in RFC 4412: “Communication Resource Priority for Session Initiation Protocol (SIP)”, may be added to Session Initiation Protocol (SIP) requests for this purpose.

Unfortunately, with the proliferation of phone call spoofing techniques, bad actors have started to use these headers to overwhelm phone systems by overloading them with call requests including the priority headers. When too many calls are prioritized, the emergency calls are not truly prioritized. There are SIP headers used for identity verification, but those too can be spoofed. Methods of cryptographically signing identity certification headers where created, such as those defined in RFC 8224: “Authenticated Identity Management in the Session Initiation Protocol (SIP)” and RFC 8225: “PASSport: Personal Assertion Token”, for example. There are also methods of combining these elements to cryptographically sign resource priority headers, such as in RFC 8443: “Personal Assertion Token (PASSport) Extension for Resource Priority Authorization”, for example.

Secure Telephone Identity Revisited (STIR) is a method of cryptographically signing the SIP header with the private key of the cellular provider for Voice over IP (VOIP) telephone systems. The SIP header may then be decrypted by the destination network using the public key of the cellular provider to confirm the accuracy of the information included in the SIP header. This information may include identity information for the device initiating the SIP call request.

Signature-based Handling of Asserted information using toKENS (SHAKEN) is an anti-spoofing technology for use in non-VoIP telephone systems. These two systems are often used together and are referred to as STIR/SHAKEN and provide a method of cryptographically ensured identity attestation.

Implementing methods of preventing spoofing, such as those discussed above, requires changes throughout the telephone networks serving the emergency callers as well as those serving the emergency networks. Some of these changes have been slow to be deployed. Until they are fully implemented, there is a situation where parts of the call routing process are able to handle cryptographically signed identity attestation and other parts are not. This leads to inefficiencies in cellular networks while work is done to cryptographically sign these call requests for destination networks that are unable to confirm the signatures and therefore simply ignore them. A method of selectively signing call requests only when the destination network would be able to effectively confirm the signature would be beneficial.

When a wireless device places an emergency call, such as a call to 911, the call request is forwarded to a P-CSCF. The P-CSCF identifies that it is an emergency call and attaches SIP headers to the call request to indicate prioritization and the identity of the calling wireless device. Some examples of the added headers are Resource Priority Header (RPH), X-MAV-RPH:911, Orig-ID and Attestation-Info. With these headers attached, the call request is forwarded to an E-CSCF. The E-CSCF then queries the GMLC to determine where to send the call request.

The GMLC manages location-based services for the cellular network. This includes determining which PSAP handles emergency calls for the region where the wireless device is calling from. The GMLC tells the E-CSCF where to forward the call request to reach the PSAP that services the wireless device's current location. The E-CSCF then forwards the call request to the cellular carrier's own SBC. The call request is then forwarded to an STI-AS for cryptographic signing. Even if the cellular carrier or PSAP do not support cryptographic identity attestation, this step proceeds and the SBC waits for the signing to be completed before forwarding the call to the PSAP at the destination network. Unless both the carrier and PSAP at the destination network support cryptographic identity attestation, this step and the subsequent wait are wasted time adding inefficiency to the emergency call system.

Implementing selective identity attestation may remove this inefficiency and wasted time. When queried by the E-CSCF, the GMLC may return which PSAP the call request is destined for and also whether that PSAP supports cryptographic identity attestation. This may be implemented with a flag entry in the record for each PSAP indicating whether the PSAP supports cryptographically signing call requests. If the PSAP does not support this signing for emergency calls, there is no need for the priority and attestation headers and the cryptographic signing. The E-CSCF may remove the headers and forward the call request to the SBC. The SBC, not seeing the headers attached to the call request may no longer wait for the call request to be signed and may simply forward it to the appropriate PSAP. If the PSAP does support emergency call signing, the process would continue as explained above with the call request being forwarded to the STI-AS for signing before being forwarded to the appropriate PSAP.

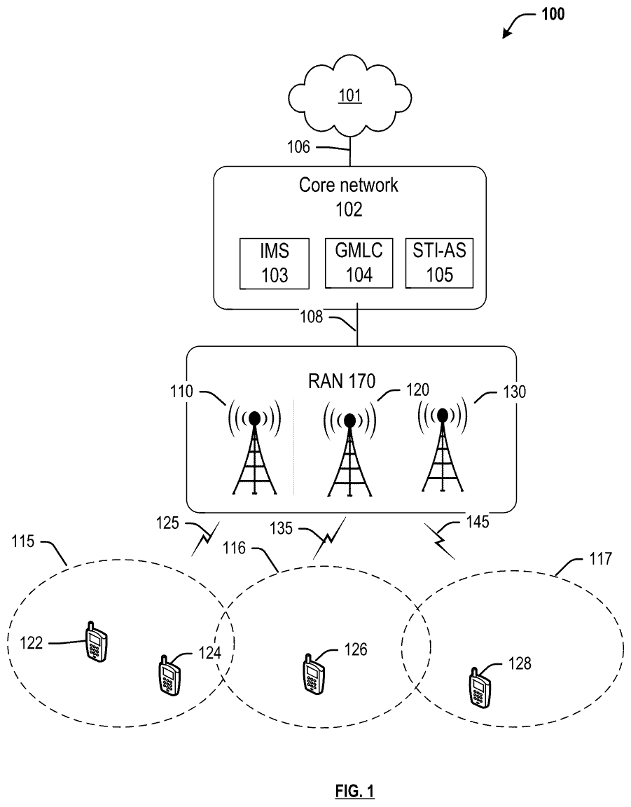

FIG. 1 depicts an exemplary system 100 for wireless communication, in accordance with the disclosed embodiments. System 100 may include a communication network 101, core network 102, and a radio access network (RAN) 170 including access nodes 110, 120, and 130. The RAN 170 may include other devices and additional access nodes. Although three access nodes are shown, any number of access nodes may be included.

System 100 also includes multiple wireless devices 122, 124, 126, and 128, which may be end-user wireless devices and may operate within one or more coverage areas 115, 116, and 117. The wireless devices 122, 124, 126, 128 communicate with access nodes 110, 120, and/or 130 within the RAN 170 over communication links 125, 135, and 145, which may for example be 4G NR communication links.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices 122, 124, 126, 128. Wireless network protocols can comprise Fifth Generation mobile networks or wireless systems (4G or 4G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

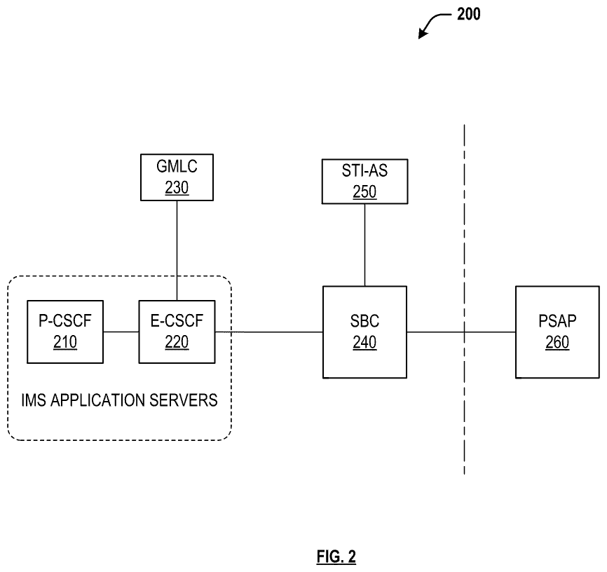

The core network 102 includes the IP Multimedia Subsystem (IMS) 103, the GMLC 104, and STI-AS 105 which will be explained further in relation to FIG. 2. The core network 102 may be separated into user plane functions and control plane functions. The user plane accesses a data network, such as network 101, and performs operations such as packet routing and forwarding, packet inspection, policy enforcement for the user plane, quality of service (QOS) handling, etc. The control plane handles radio-specific functionality that depends on the idle or connected states of the wireless devices 122, 124, 126, and 128.

Communication links 106 and 108 can use various communication media, such as air, space, metal, optical fiber, or some other signal propagation path-including combinations thereof. Communication links 106 and 108 can be wired or wireless and use various communication protocols such as Internet, Internet protocol (IP), local-area network (LAN), S1, optical networking, hybrid fiber coax (HFC), telephony, T1, or some other communication format-including combinations, improvements, or variations thereof. Wireless communication links may use electromagnetic waves in the radio frequency (RF), microwave, infrared (IR), or other wavelength ranges, and may use a suitable communication protocol, including 4G including 4G NR or 4G Advanced, 6G, NTN, or combinations thereof.

Communication links 106 and 108 can be direct links or might include various equipment, intermediate components, systems, and networks, such as a cell site router, etc. Communication links 106 and 108 may comprise many different signals sharing the same link.

The RAN 170 may include various access network systems and devices such as access nodes 110, 120, 130. The RAN 170 is disposed between the core network 102 and the end-user wireless devices 122, 124, 126, 128. Components of the RAN 170 may communicate directly with the core network 102 and others may communicate directly with the end user wireless devices 122, 124, 126, 128. The RAN 170 may provide services from the core network 102 to the end-user wireless devices 122, 124, 126, and 128.

The RAN 170 includes multiple access nodes (or base stations) 110, 120, 130, which may include one or more access nodes communicating with the plurality of end-user wireless devices 122, 124, 126, 128. It should be understood that the disclosed technology may also be applied to communication between an end-user wireless device and other network resources, such as relay nodes, controller nodes, antennas, etc. The RAN 170 may further comprise a non-terrestrial network (NTN) serving the multiple UEs by a radio frequency transmission provided by utilizing orbiting satellites that may be in communication with access nodes of a terrestrial network (TN). The satellites may include geosynchronous equatorial orbit (GEO) satellites, Medium Earth Orbit (MEO) satellites, and low Earth orbit (LEO) satellites. The NTN may include NTN nodes that are not stationed on the ground.

Access nodes 110, 120, 130 can be, for example, standard access nodes such as a macro-cell access node, a base transceiver station, a radio base station, an evolved NodeB (or eNodeB) in 4G or 4G LTE, a next generation NodeB (or gNodeB) in 5G New Radio (“5G NR”), or the like. In additional embodiments, access nodes may comprise two co-located cells, or antenna/transceiver combinations that are mounted on the same structure. Alternatively, access nodes 110, 120, 130 may comprise a short range, low power, small-cell access node such as a microcell access node, a picocell access node, a femtocell access node. Access nodes 110, 120, 130 can be configured to deploy one or more different carriers, utilizing one or more RATs. Any other combination of access nodes and carriers deployed therefrom may be evident to those having ordinary skill in the art in light of this disclosure.

The access nodes 110, 120, 130, servers in the IMS 103, the GMLC 104 and STI-AS 105 may comprise a processor and associated circuitry to execute or direct the execution of computer-readable instructions. They may retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The wireless devices 122, 124, 126, and 128 may include any wireless device included in a wireless network. For example, the term “wireless device” may include a relay node, which may communicate with an access node. The term “wireless device” may also include an end-user wireless device, which may communicate with the access node through a relay node. The term “wireless device” may further include an end-user wireless device that communicates with the access node directly without being relayed by a relay node. Wireless devices 122, 124, 126, and 128 may be any device, system, combination of devices, or other such communication platform capable of communicating wirelessly with access node 110, 120, and 130 using one or more frequency bands and wireless carriers deployed therefrom. Each of wireless devices 122, 124, 126, and 128, may be, for example, a mobile phone, a wireless phone, a wireless modem, a personal digital assistant (PDA), a voice over internet protocol (VoIP) phone, a voice over packet (VOP) phone, or a soft phone, a wearable device, an internet of things (IoT) device, as well as other types of devices or systems that can send and receive audio or data. The wireless devices 122, 124, 126 128 may be or include high power wireless devices or standard power wireless devices.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork (including the Internet). Communication system 100 may be capable of communicating signals and carrying data, for example, to support voice, push-to-talk, broadcast video, and data communications by end-user wireless devices 122, 124, 126, and 128.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g., between the radio access network 170 and the core network 102.

FIG. 2 illustrates an example operating environment for selective attestation for emergency calls. IMS servers P-CSCF 210 and E-CSCF 220 are shown, but it should be understood that there are many other types of IMS servers that are omitted for clarity. A proxy server, such as P-CSCF 210 receives an emergency call request from a wireless device. Headers may be added to the call request in the form of SIP headers such as Resource Priority Header (RPH), X-MAV-RPH:911, Orig. ID, and Attestation-Info. The call request may then be forwarded to an emergency call management server such as E-CSCF 220 for further processing. E-CSCF 220 may query the GMLC 230 for information about the destination network of the call. The GMLC 230 returns information on the PSAP 260 that services the location of the wireless device that originated the call request. This information includes how to contact the PSAP 260 as well as whether the PSAP 260 supports emergency call signing. This may be indicated by a flag in the record of the PSAP 260.

If the PSAP 260 of the destination network supports emergency call signing, the call request is forwarded to the session border controller, such as SBC 240 with the headers intact. However, if the PSAP 260 does not support emergency call signing, the extraneous headers are removed before forwarding the call request to SBC 240. If the call request has identity attestation headers when it reaches SBC 240, SBC 240 forwards the call request to an authentication server, such as STI-AS 250 to be cryptographically signed and returned to SBC 240 as a signed call request. SBC 240 forwards the call request or the signed call request to PSAP 260 in the destination network to complete the call.

Alternatively, SBC 240 may forward all call requests to STI-AS 250 regardless of whether the call request has identity attestation headers. If the call request does not have the headers, SBC 240 has no need to wait for STI-AS 250 to return a message indicating it cannot sign the call request, but instead SBC 240 may immediately forward the unsigned call request to PSAP 260.

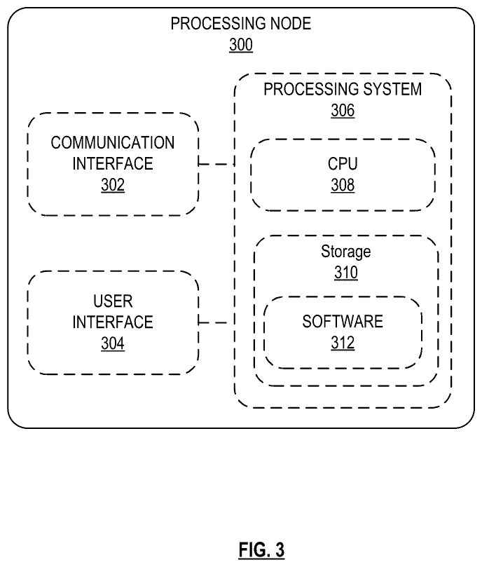

FIG. 3 depicts an example processing node 300, which may be configured to perform the methods and operations disclosed herein for selective attestation for emergency calls. The processing node 300 includes a communication interface 302, user interface 304, and processing system 306 in communication with communication interface 302 and user interface 304. Communication interface 302 may include hardware components, such as network communication ports, devices, routers, wires, antenna, transceivers, etc. User interface 304 may include hardware components, such as touch screens, buttons, displays, speakers, etc.

Processing system 306 includes a processor 308, storage 310, which can comprise a disk drive, flash drive, memory circuitry, or other memory device including, for example, a buffer. Storage 310 can store software 312 which is used in the operation of the processing node 300. Software 312 may include computer programs, firmware, or some other form of machine-readable instructions, including an operating system, utilities, drivers, network interfaces, applications, or some other type of software. Processing system 306 may include a processor 308 and other circuitry to retrieve and execute software 312 from storage 310, which may be internal or external to the processing system 306. Processing node 300 may further include other components such as a power management unit, a control interface unit, etc., which are omitted for clarity. Communication interface 302 permits processing node 300 to communicate with other network elements. User interface 304 permits the configuration and control of the operation of processing node 300. Processing node 300 may be included in various elements of the wireless network including an access node, P-CSCF, E-CSCF, GMLC, STI-AS, SBC, or PSAP for example.

In an exemplary embodiment, software 212 may include instructions for receiving a call request for a wireless device from a proxy server (e.g. a P-CSCF server, for example). The instructions may further include querying a Gateway Mobile Location Center (GMLC) to determine whether a destination network for the call request supports emergency call signing. The GMLC has access to records for the PSAPs that it knows about. The records include information about what locations each PSAP provides service for, how to contact the PSAP, and may include a flag indicating whether or not the PSAP supports emergency call signing. The instructions may further include in response to determining that the destination network for the call request supports emergency call signing, forwarding the call request with headers providing identity attestation for the wireless device. The identity attestation headers may include one or more of the following: Resource Priority Header (RPH), X-MAV-RPH:911, Orig. ID, and Attestation-Info.

The instructions may further include in response to determining that the destination network for the call request does not support emergency call singing, removing the identity attestation headers and forwarding the call request to the destination network without signing the call request. If the destination network supports emergency call signing, the instructions may further include forwarding the call request to an authentication server to be signed, receiving a signed call request from the authentication server and forwarding the signed call request to the destination network.

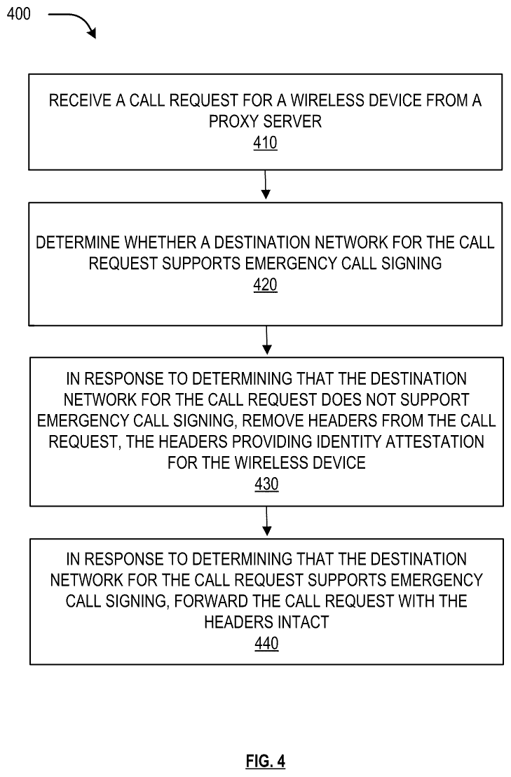

FIG. 4 illustrates an exemplary method 400 of selective attestation for emergency calls. Method 400 may be performed by any suitable combination of processors discussed herein, for example a processor contained in an emergency call management server, such as an E-CSCF server.

Method 400 begins in step 410 where a call request for a wireless device is received from a proxy server. Method 400 continues in step 420 where it is determined whether a destination network for the call request supports emergency call signing. Determining whether the destination network for the call request supports emergency call signing may be accomplished by querying a Gateway Mobile Location Center (GMLC). The GMLC stores information about the destination network, such as which PSAP services which locations. Included in this information may be a flag indicating whether the PSAP supports emergency call signing.

Method 400 continues in step 430 where, in response to determining that the destination network for the call request does not support emergency call signing, the headers providing identity attestation for the wireless device are removed from the call request. The headers may be one or more of Resource Priority Header (RPH), X-MAV-RPH:911, Orig. ID, and Attestation-Info.

Method 400 continues in step 440 where, in response to determining that the destination network for the call request supports emergency call signing, the call request is forwarded with the headers intact. This call request may be forwarded to an authentication server, such as the STI-AS server discussed above. The authentication server may cryptographically sign the call request and then send it to a border controller which forwards it on to the destination network.

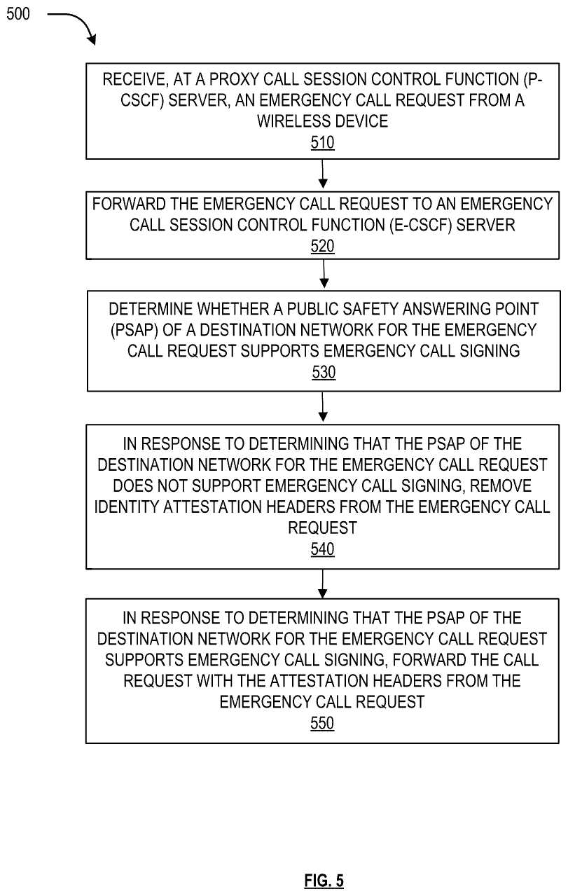

FIG. 5 illustrates an exemplary method 500 of selective attestation for emergency calls. Method 500 may be performed by any suitable combination of processors discussed herein, for example a processor contained in an emergency call management server, such as an E-CSCF server.

Method 500 begins in step 510 where an emergency call request is received at a Proxy Call Session Control Function (P-CSCF) from a wireless device. Method 500 continues in step 520 where the emergency call request is forwarded to an Emergency Call Session Control Function (E-CSCF) server. Method 500 continues in step 530 where it is determined whether a Public Safety Answering Point (PSAP) of a destination network for the emergency call request supports emergency call signing. Determining whether the destination network's PSAP supports emergency call signing may be accomplished by querying a Gateway Mobile Location Center (GMLC). The GMLC stores information about the destination network, such as which PSAP services which locations. Included in this information may be a flag indicating whether the PSAP supports emergency call signing.

Method 500 continues in step 540 where identity attestation headers are removed from the emergency call request in response to determining that the PSAP of the destination network for the emergency call request does not support emergency call signing. The identity attestation headers may be one or more of Resource Priority Header (RPH), X-MAV-RPH:911, Orig. ID, and Attestation-Info.

In step 550, in response to determining that the PSAP of the destination network for the emergency call request supports emergency call signing, the emergency call request is forwarded with the headers intact. This emergency call request may be forwarded to an authentication server, such as the STI-AS server discussed above. The authentication server may cryptographically sign the emergency call request which may then be sent to a border controller, such as a Session Border Controller, which forwards it on to the PSAP of the destination network.

In some embodiments, methods 400 and 500 may include additional steps or operations. Furthermore, the methods may include steps shown in each of the other methods. As one of ordinary skill in the art would understand, the methods of 400 and 500 may be integrated in any useful manner and the steps may be performed in any useful sequence.

The exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, the method comprising:
receiving a call request for a wireless device from a proxy server;
determining whether a destination network for the call request supports emergency call signing; and
in response to determining that the destination network for the call request does not support emergency call signing, removing headers from the call request, the headers providing identity attestation for the wireless device.

2. The method of claim 1, wherein the headers comprise at least one of: Resource Priority Header (RPH), X-MAV-RPH:911, Orig. ID, and Attestation-Info.

3. The method of claim 1, wherein the determining whether the destination network for the call request supports emergency call signing comprises querying a Gateway Mobile Location Center.

4. The method of claim 1, the method further comprising:
in response to removing the headers from the call request, forwarding the call request to the destination network without signing the call request.

5. The method of claim 1, the method further comprising:
in response to determining that the destination network for the call request supports emergency call signing, forwarding the call request with the headers intact.

6. The method of claim 5, the method further comprising:
forwarding the call request to an authentication server to be signed.

7. The method of claim 6, the method further comprising:
receiving a signed call request from the authentication server; and
forwarding the signed call request to the destination network.

8. A method, the method comprising:
receiving at a Proxy Call Session Control Function (P-CSCF) server an emergency call request from a wireless device;
forwarding the emergency call request to an Emergency Call Session Control Function (E-CSCF) server;
determining whether a Public Safety Answering Point (PSAP) of a destination network for the emergency call request supports emergency call signing; and
in response to determining that the PSAP of the destination network for the emergency call request does not support emergency call signing, removing identity attestation headers from the emergency call request.

9. The method of claim 8, wherein the identity attestation headers comprise at least one of: Resource Priority Header (RPH), X-MAV-RPH:911, Orig. ID, and Attestation-Info.

10. The method of claim 8, wherein the determining whether the PSAP of the destination network for the emergency call request supports emergency call signing comprises querying a Gateway Mobile Location Center.

11. The method of claim 8, the method further comprising:
in response to removing the identity attestation headers from the emergency call request, forwarding the emergency call request to the destination network without signing the emergency call request.

12. The method of claim 8, the method further comprising:
in response to determining that the PSAP of the destination network for the emergency call request does support emergency call signing, forwarding the emergency call request with the identity attestation headers intact.

13. The method of claim 12, the method further comprising:
forwarding the emergency call request to an authentication server to be signed.

14. The method of claim 13, the method further comprising:
receiving a signed call request from the authentication server at a Session Border Controller; and
forwarding the signed call request to the PSAP of the destination network.

15. A system, the system comprising:
a proxy server; and
an emergency call management server, including at least one electronic processor configured for executing instructions to perform operations including:
receiving a call request for a wireless device from the proxy server;
querying a Gateway Mobile Location Center (GMLC) to determine whether a destination network for the call request supports emergency call signing; and
in response to determining that the destination network for the call request supports emergency call signing, forwarding the call request with headers providing identity attestation for the wireless device.

16. The system of claim 15, wherein the headers providing identity attestation comprise at least one of: Resource Priority Header (RPH), X-MAV-RPH:911, Orig. ID, and Attestation-Info.

17. The system of claim 15, wherein a flag in a record at the GMLC for a Public Safety Answering Point (PSAP) of the destination network for the call request indicates whether the destination network for the call request supports emergency call signing.

18. The system of claim 15, the operations further comprising:
in response to determining that the destination network for the call request does not support emergency call signing, removing the headers providing identity attestation from the call request, and forwarding the call request to the destination network without signing the call request.

19. The system of claim 15, the operations further comprising:
forwarding the call request to an authentication server to be signed.

20. The system of claim 19, the operations further comprising:
receiving a signed call request from the authentication server; and
forwarding the signed call request to the destination network.
